(19) United States
(12) Patent Application Publication
(10) Pub. No.: US 2022/0058641 A1
(43) Pub. Date: Feb. 24, 2022

(54) DEVICE AND METHOD FOR PROCESSING DATA OF TRANSACTIONS BASED ON BLOCK CHAIN, AND STORAGE MEDIUM

(71) Applicant: HON HAI PRECISION INDUSTRY CO., LTD., New Taipei (TW)

(72) Inventor: WUN-CING LAI, New Taipei (TW)

(21) Appl. No.: 17/404,584

(22) Filed: Aug. 17, 2021

(30) Foreign Application Priority Data
Aug. 19, 2020 (CN) 202010839163.4

(51) Int. Cl. G06Q 20/38; G06Q 20/06

(52) U.S. Cl. CPC G06Q 20/3825; G06Q 20/065; G06Q 20/38215; G06Q 20/3827

(57) ABSTRACT

A method for processing data of transactions in a block chain system which applies a time control to a transfer of assets receives from a first user an asset transferring request, generating an asset transferring permission accordingly. If a current blockchain time meets a first time condition, assets recorded as the content of an asset transfer are allowed to be transferred from a first account address to a second account address. An asset transaction request from a second user can be received, and an asset transaction permission also generated accordingly. If current blockchain time meets a second time condition of the asset transaction permission, the second user and a third user, for asset forwarding or asset return purposes for example, may trade in relation to the permitted asset transaction content. A device for processing such data is also provided.

### FIELD

The subject matter herein generally relates to transaction data processing by block chain.

### BACKGROUND

Block chain technology provides distributed data storage, point-to-point transmission, a consensus mechanism, and encryption algorithms. The block chain technology employs a consensus mechanism such as Proof of Work to achieve validation of a block in a chain. A mathematical algorithm can establish rights between different nodes in the block chain system. In block chain technology, a user A1 can be authorized to obtain an amount of tokens from a user B1 through an approval interface. There is no time limit in process of transferring the above-mentioned tokens.

Thus, there is room for improvement.

### BRIEF DESCRIPTION OF THE DRAWINGS

Implementations of the present disclosure will now be described, by way of embodiments, with reference to the attached figures.

FIG. 1 illustrates a block view of an embodiment of a device for processing transaction data utilizing a block chain system.

FIG. 2 illustrates a block view of an embodiment of a procedure for processing transaction data of the device of FIG. 1.

FIG. 3 illustrates a flowchart of an embodiment of a method for processing transaction data utilizing the block chain system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to”; it specifically indicates open-ended inclusion or membership in the so-described combination, group, series, and the like.

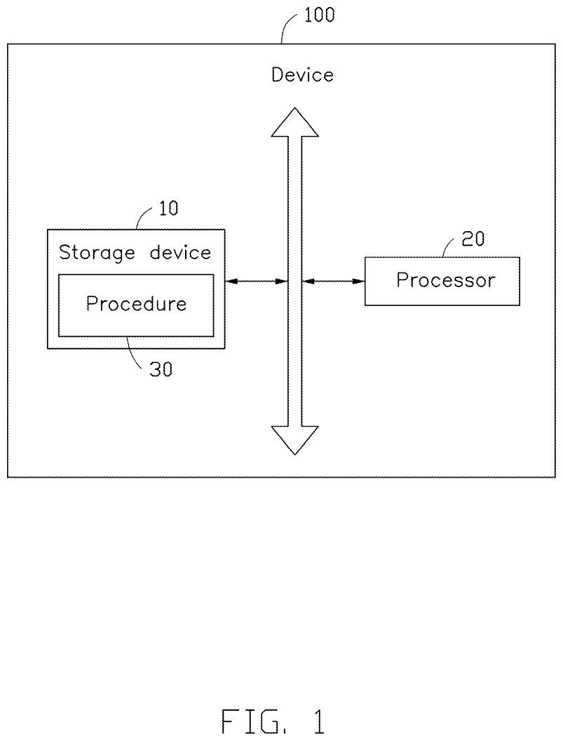

FIG. 1 illustrates a block view of an embodiment of a device (device 100) for processing transaction data based on the block chain system.

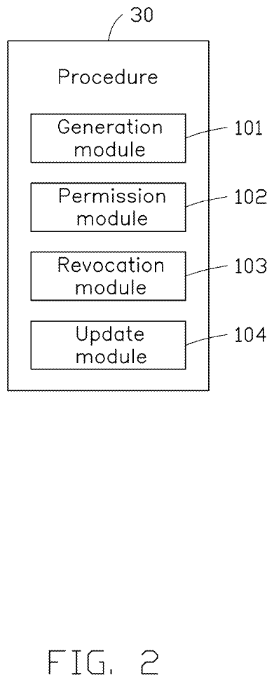

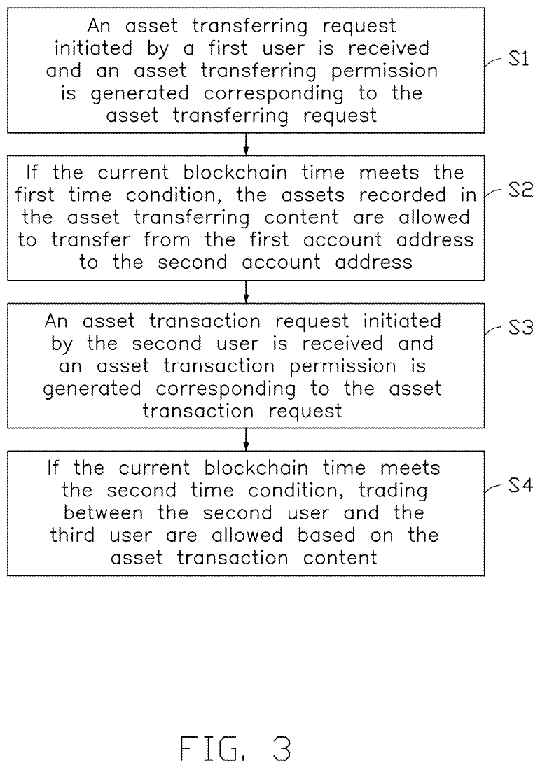

In one embodiment, the device 100 can comprise a storage device 10, at least one processor 20, and a procedure for processing data of transactions (procedure 30) stored in the storage device 10. The procedure 30 can be run on the at least one processor 20. The at least one processor 20 can execute the procedure 30 to accomplish the steps of a method for processing transaction data, for example, the steps S1-S4 of FIG. 3. The at least one processor 20 can alternatively execute the procedure 30 to accomplish the function of the modules of the procedure 30, for example, to accomplish the function of the modules 101-104 of FIG. 2.

The procedure 30 can be divided into one or more modules/units. The one or more modules/units can be stored in the storage device 10 and executed by the at least one processor 20. The one or more modules/units can be a series of program instruction segments, which can perform specific functions, and the instruction segment is configured to describe the execution process of the procedure 30 in the device 100. For example, the procedure 30 can be divided into a generation module 101, a permission module 102, a revocation module 103, and an update module 104, as shown in FIG. 2. The detail function of each module is described in FIG. 2.

It can be understood that, the block view exemplified in FIG. 1 is an example of the device 100. The block view is not to be considered as limiting the device 100. Additional components can be added in other examples, or fewer components can be utilized, or some components can be combined, or different components can be used without departing from this disclosure. For example, the device 100 may comprise a network accessing device, a bus, or the like.

In one embodiment, the transaction device 100 may be a server of a blockchain transaction platform.

The at least one processor 20 can be one or more central processing units, or it can be one or more other universal processors, digital signal processors, application specific integrated circuits, field-programmable gate arrays, or other programmable logic devices, discrete gate or transistor logic, discrete hardware components, and so on. The at least one processor 20 can be a microprocessor or any regular processor, or the like.

The storage device 10 stores the procedure 30 and/or modules/units. The at least one processor 20 can run or execute the procedure 30 and/or modules/units stored in the storage device 10, and accomplish the various functions of the device 100. In addition, the storage device 10 can include a non-transitory storage medium, such as hard disk, memory, plug-in hard disk, smart media card, secure digital, flash card, at least one disk storage device, flash memory, or other transitory storage medium.

In one embodiment, the block chain system may comprises a block chain network and a chain of data blocks. The block chain network includes a number of nodes. Each node records and saves block chain addresses of multiple block chain accounts. Users, for example block chain users, employ a unique block chain address to represent their identity and associated funds, and employs a set of public keywords and private keywords to identify themselves and protect their funds. Each block chain user can use a client terminal, for example, a computer, a smart phone, or the like, to communicate and interact with any other node. For example, the block chain user can communicate with any node through a webpage or an application of a smart phone.

In can be understood that, each node takes account of the blocks based on the consensus mechanism. When any node broadcasts information or the block to the block chain network, the other nodes receive and verify the received block. When a ratio of a quantity of verified nodes to a quantity of total nodes in the block chain network is greater than a predetermined threshold, the verification of the block chain network to the block is determined to be passed, and all nodes can accept and take account of the block.

FIG. 2 illustrates a block view of an embodiment of the procedure 30.

The procedure 30 can comprise the generation module 101, the permission module 102, the revocation module 103, and the update module 104. In one embodiment, the modules can be stored in the storage device 10 and can be run on the at least one processor 20. It can be understood that, in other embodiments, the modules can be instructions or firmware resident in the at least one processor 20.

The generation module 101 receives from a first user a request to transfer assets and an asset transferring permission can be generated accordingly.

In one embodiment, the asset transferring permission can comprise a first account address corresponding to the first user, a second account address corresponding to a second user, an asset transferring content, and a first time condition. The asset transferring permission can stipulate that if a current time of the block chain system (current blockchain time) meets the first time condition, assets recorded in the asset transferring content can be freely transferred to the second account address from the first account address.

In one embodiment, the asset transferring permission can be stored in a form of a mapping. The second account address, the asset transferring content, and the first time condition can be obtained based on the first account address. The assets recorded in the asset transferring content are a first number of tokens. The first time condition can comprise a time range that is later than a first predetermined time, a time range that is earlier than the first predetermined time, or a time range that is within the first predetermined time and a second predetermined time.

For example, the asset transferring permission is described as “an account address A1=>an account address B1=>a first time=>a first amount of tokens”, the asset transferring permission can indicate that the account address A1 allows the account address B1 to transfer the first amount of tokens owned by the account address A1 after the first time. Then, a function similar to an issuance of checks can be realized.

If the current blockchain time meets the first time condition, the permission module 102 allows the transfer of the assets recorded in the asset transferring content from the first account address to the second account address. If the current blockchain time does not meet the first time condition, the permission module 102 prevents the transfer of the assets recorded in the asset transferring content from the first account address to the second account address.

In one embodiment, if the current blockchain time does not meet the first time condition, the generation module 101 can further receive a revocation request of asset transferring initiated by the first user. The revocation module 103 can revoke the asset transferring permission according to the revocation request. Then, the assets recorded in the asset transferring content are canceled in any transfer from the first account address to the second account address based on the revocation request.

In one embodiment, if the current blockchain time does not meet the first time condition, the generation module 101 can further receive a modification request of asset transferring initiated by the first user. The update module 104 can modify the asset transferring content and/or the first time condition according to the modification request.

In one embodiment, the generation module 101 can further receive an asset transaction request initiated by the second user and generate an asset transaction permission corresponding to the asset transaction request. The asset transaction permission can comprise the second account address, a third account address corresponding to a third user, an asset transaction content, and a second time condition. The asset transaction permission can stipulate that if a current time of the block chain system meets the second time condition, the trading between the second user and the third user are allowed based on the asset transaction content.

In one embodiment, the first user and the third user are the same user, and the first account address is the same as the third account address. At this time, the second user is trading with the first user. The first user and the third user can also be different users, and the first account address and the third account address can also be different addresses. At this time, the second user trades with the third user who is different from the first user.

In one embodiment, the asset transaction permission can be stored in a form of a mapping. The third account address, the asset transaction content, and the second time condition can be obtained based on the second account address. The asset transaction content comprises a second number of tokens. The second time condition can comprise a time range that is later than a third predetermined time, a time range that is earlier than the third predetermined time, or a time range that is within the third predetermined time and a fourth predetermined time.

For example, the asset transaction permission is described as “an account address A2=>an account address B2=>a second time=>a second amount of tokens”, the asset transaction permission can indicate that the account address A2 allows the account address B2 to trade the second amount of tokens with the account address A2 after the second time.

In one embodiment, if the current blockchain time meets the second time condition, the permission module 102 can allow trading between the second user and the third user based on the asset transaction content. If the current blockchain time does not meet the second time condition, the permission module 102 can prevent trading between the second user and the third user according to the asset transaction content.

In one embodiment, if the current blockchain time does not meet the second time condition, the generation module 101 can further receive a revocation request of asset transaction initiated by the second user. The revocation module 103 can revoke the asset transaction permission according to the revocation request of asset transaction. Then, a trading with respect to the asset transaction content between the second user and the third user can be canceled based on the revocation request.

In one embodiment, if the current blockchain time does not meet the second time condition, the generation module 101 can further receive a modification request of asset transaction initiated by the second user. The update module 104 can modify the asset transaction content and/or the second time condition according to the modification request.

FIG. 3 illustrates one exemplary embodiment of a method for processing transaction data based on a block chain system. The flowchart presents an exemplary embodiment of the method. The exemplary method is provided by way of example, as there are a variety of ways to carry out the method. The method described below can be carried out using the configurations illustrated in FIG. 2, for example, and various elements of these figures are referenced in explaining the example method. Each block shown in FIG. 3 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block S1.

In block S1, an asset transferring request initiated by a first user is received and an asset transferring permission is generated corresponding to the asset transferring request.

In one embodiment, the asset transferring request initiated by the first user can be received by the generation module 101. The asset transferring permission can be generated by the generation module 101 corresponding to the asset transferring request. The asset transferring permission can comprise a first account address corresponding to the first user, a second account address corresponding to a second user, an asset transferring content, and a first time condition. The asset transferring permission can stipulate that if a current time of the block chain system (current blockchain time) meets the first time condition, assets recorded in the asset transferring content can be freely transferred to the second account address from the first account address.

In one embodiment, the asset transferring permission can be stored in a form of a mapping. The second account address, the asset transferring content, and the first time condition can be obtained based on the first account address. The assets recorded in the asset transferring content are a first number of tokens. The first time condition can comprise a time range that is later than a first predetermined time, a time range that is earlier than the first predetermined time, or a time range that is within the first predetermined time and a second predetermined time.

For example, the asset transferring permission is described as “an account address A1=>an account address B1=>a first time=>a first amount of tokens”, the asset transferring permission can indicate that the account address A1 allows the account address B1 to transfer the first amount of tokens owned by the account address A1 after the first time. Then, a function similar to an issuance of checks can be realized.

In block S2, if the current blockchain time meets the first time condition, the assets recorded in the asset transferring content are allowed to transfer from the first account address to the second account address.

If the current blockchain time does not meet the first time condition, the assets recorded in the asset transferring content is prevented to transfer from the first account address to the second account address.

In one embodiment, if the current blockchain time does not meet the first time condition, a revocation request of asset transferring initiated by the first user can be received by the generation module 101. The asset transferring permission can be revoked by the revocation nodule 103 according to the revocation request. Then, the assets recorded in the asset transferring content is canceled in any transfer from the first account address to the second account address based on the revocation request.

In one embodiment, if the current blockchain time does not meet the first time condition, a modification request of asset transferring initiated by the first user can be received by the generation module 101. The asset transferring content and/or the first time condition can be modified by the update module 104 according to the modification request.

In block S3, an asset transaction request initiated by the second user is received and an asset transaction permission is generated corresponding to the asset transaction request.

In one embodiment, the asset transaction permission can comprise the second account address, a third account address corresponding to a third user, an asset transaction content, and a second time condition. The asset transaction permission can stipulate that if a current time of the block chain system meets the second time condition, the trading between the second user and the third user are allowed based on the asset transaction content.

In one embodiment, the first user and the third user are the same user, and the first account address is the same as the third account address. At this time, the second user is trading with the first user. The first user and the third user can also be different users, and the first account address and the third account address can also be different addresses. At this time, the second user trades with the third user who is different from the first user.

In one embodiment, the asset transaction permission can be stored in a form of a mapping. The third account address, the asset transaction content, and the second time condition can be obtained based on the second account address. The asset transaction content comprises a second number of tokens. The second time condition can comprise a time range that is later than a third predetermined time, a time range that is earlier than the third predetermined time, or a time range that is within the third predetermined time and a fourth predetermined time.

For example, the asset transaction permission is described as “an account address A2=>an account address B2=>a second time=>a second amount of tokens”, the asset transaction permission can indicate that the account address A2 allows the account address B2 to trade the second amount of tokens with the account address A2 after the second time.

In block S4, if the current blockchain time meets the second time condition, trading between the second user and the third user are allowed based on the asset transaction content.

If the current blockchain time does not meet the second time condition, the trading between the second user and the third user is prevented according to the asset transaction content.

In one embodiment, if the current blockchain time does not meet the second time condition, a revocation request of asset transaction initiated by the second user can be received by the generation module 101. The asset transaction permission can be revoked by the revocation module 103 according to the revocation request of asset transaction. Then, a trading with respect to the asset transaction content between the second user and the third user can be canceled based on the revocation request.

In one embodiment, if the current blockchain time does not meet the second time condition, a modification request of asset transaction initiated by the second user can be received. The asset transaction content and/or the second time condition can be modified by the update module 104 according to the modification request.

The embodiments shown and described above are only examples. Many details known in the relevant field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A method for processing transaction data based on a block chain system, the method comprising:
receiving an asset transferring request initiated by a first user;
generating an asset transferring permission corresponding to the asset transferring request, wherein the asset transferring permission comprises a first account address corresponding to the first user, a second account address corresponding to a second user, an asset transferring content, and a first time condition;
if a current blockchain time meets the first time condition, allowing to transfer assets recorded in the asset transferring content from the first account address to the second account address;
receiving an asset transaction request initiated by the second user;
generating an asset transaction permission corresponding to the asset transaction request, wherein the asset transaction permission comprises the second account address, a third account address corresponding to a third user, an asset transaction content, and a second time condition; and
if the current blockchain time meets the second time condition, allowing trading between the second user and the third user based on the asset transaction content.

2. The method of claim 1, wherein the first user and the third user are the same user, and the first account address is the same as the third account address.

3. The method of claim 1, further comprising:
if the current blockchain time does not meet the first time condition, preventing to transfer the assets recorded in the asset transferring content from the first account address to the second account address; or
if the current blockchain time does not meet the second time condition, preventing the trading between the second user and the third user according to the asset transaction content.

4. The method of claim 1, further comprising:
if the current blockchain time does not meet the first time condition, receiving a revocation request of asset transferring initiated by the first user; and
revoking the asset transferring permission of transferring the assets recorded in the asset transferring content from the first account address to the second account address according to the revocation request of asset transferring.

5. The method of claim 1, further comprising:
if the current blockchain time does not meet the first time condition, receiving a modification request of asset transferring initiated by the first user; and
modifying the asset transferring content and/or the first time condition according to the modification request of asset transferring.

6. The method of claim 1, further comprising:
if the current blockchain time does not meet the second time condition, receiving a revocation request of asset transaction initiated by the second user; and
revoking the asset transaction permission of a trading with respect to the asset transaction content between the second user and the third user according to the revocation request of asset transaction.

7. The method of claim 1, further comprising:
if the current blockchain time does not meet the second time condition, receiving a modification request of asset transaction initiated by the second user; and
modifying the asset transaction content and/or the second time condition according to the modification request of asset transaction.

8. The method of claim 1, wherein the asset transferring request and the asset transaction request are stored in a form of a mapping, the second account address, the asset transferring content, and the first time condition are obtained based on the first account address, and the third account address, the asset transaction content, and the second time condition are obtained based on the second account address.

9. A device for processing transaction data based on a block chain system, the device comprising:
a storage device; and
at least one processor;
wherein the storage device stores one or more programs, which when executed by the at least one processor, cause the at least one processor to:
receive an asset transferring request initiated by a first user;
generate an asset transferring permission corresponding to the asset transferring request, wherein the asset transferring permission comprises a first account address corresponding to the first user, a second account address corresponding to a second user, an asset transferring content, and a first time condition;
if a current blockchain time meets the first time condition, allow to transfer assets recorded in the asset transferring content from the first account address to the second account address;
receive an asset transaction request initiated by the second user;
generate an asset transaction permission corresponding to the asset transaction request, wherein the asset transaction permission comprises the second account address, a third account address corresponding to a third user, an asset transaction content, and a second time condition; and
if the current blockchain time meets the second time condition, allow trading between the second user and the third user based on the asset transaction content.

10. The device of claim 9, wherein the first user and the third user are the same user, and the first account address is the same as the third account address.

11. The device of claim 9, wherein the at least one processor is further configured to:
if the current blockchain time does not meet the first time condition, prevent to transfer the assets recorded in the asset transferring content from the first account address to the second account address; or
if the current blockchain time does not meet the second time condition, prevent the trading between the second user and the third user according to the asset transaction content.

12. The device of claim 9, wherein the at least one processor is further configured to:
if the current blockchain time does not meet the first time condition, receive a revocation request of asset transferring initiated by the first user; and
revoke the asset transferring permission of transferring the assets recorded in the asset transferring content from the first account address to the second account address according to the revocation request of asset transferring.

13. The device of claim 9, wherein the at least one processor is further configured to:
if the current blockchain time does not meet the first time condition, receive a modification request of asset transferring initiated by the first user; and
modify the asset transferring content and/or the first time condition according to the modification request of asset transferring.

14. The device of claim 9, wherein the at least one processor is further configured to:
if the current blockchain time does not meet the second time condition, receive a revocation request of asset transaction initiated by the second user; and
revoke the asset transaction permission of a trading with respect to the asset transaction content between the second user and the third user according to the revocation request of asset transaction.

15. The device of claim 9, wherein the at least one processor is further configured to:
if the current blockchain time does not meet the second time condition, receive a modification request of asset transaction initiated by the second user; and
modify the asset transaction content and/or the second time condition according to the modification request of asset transaction.

16. The device of claim 9, wherein the asset transferring request and the asset transaction request are stored in a form of a mapping, the second account address, the asset transferring content, and the first time condition are obtained based on the first account address, and the third account address, the asset transaction content, and the second time condition are obtained based on the second account address.

17. A non-transitory storage medium having stored thereon instructions that, when executed by a processor of an electronic device, causes the electronic device to perform a method for processing transaction data based on a block chain system, the method comprising:
receiving an asset transferring request initiated by a first user;
generating an asset transferring permission corresponding to the asset transferring request, wherein the asset transferring permission comprises a first account address corresponding to the first user, a second account address corresponding to a second user, an asset transferring content, and a first time condition;
if a current blockchain time meets the first time condition, allowing to transfer assets recorded in the asset transferring content from the first account address to the second account address;
receiving an asset transaction request initiated by the second user;
generating an asset transaction permission corresponding to the asset transaction request, wherein the asset transaction permission comprises the second account address, a third account address corresponding to a third user, an asset transaction content, and a second time condition; and
if the current blockchain time meets the second time condition, allowing trading between the second user and the third user based on the asset transaction content.
